(19) United States
(12) Patent Application Publication
(10) Pub. No.: US 2011/0109442 A1
(43) Pub. Date: May 12, 2011

(54) Passive RFID tag reader/locator

(76) Inventors: George Pavlov, Ottawa (CA); Jim Wight, Ottawa (CA); Ying Shao, Kanata (CA); Sanjay Chadha, Ottawa (CA)

(21) Appl. No.: 12/591,208

(22) Filed: Nov. 12, 2009

(51) Int. Cl. H04Q 5/22

(52) U.S. Cl. 340/10.4

(57) ABSTRACT

Systems and methods for use in reading and locating passive RFID tags. A reader/locator system sends out a signal with varying frequency. A tag reflects the signal back and the receiver portion of the reader/locator system receives the signal after a certain propagation delay. Since during this propagation delay the transmit frequency has changed, the received signal frequency differs from the one is currently transmitted. The received signal gets mixed with the currently transmitted signal and the resulting beat frequency depends on the frequency variation pattern (which is known) and the signal propagation delay. This beat frequency is directly proportional to the distance between the reader/locator and the RFID tag. The beat frequency can therefore be used to estimate this distance between the reader/locator and the RFID tag. Also provided are methods for determining if an incoming signal is data bearing and a method to obtain a cleaner incoming signal by storing a “carbon footprint” or background clutter and subtracting the carbon footprint from the incoming signal. A novel type of passive RFID tag is also disclosed.

### TECHNICAL FIELD

The present invention relates to radio frequency identification (RFID) tags. More specifically, the present invention relates to methods and devices relating to a reader/locator for use with passive RFID tags.

### BACKGROUND OF THE INVENTION

The RFID tag is attached to an object and then scanned or interrogated using radio frequency electromagnetic waves emitted from an interrogator. Interrogating the RFID tags with radio waves allows the interrogator to be out of direct line-of-sight of the tagged item and to be located at a greater distance from the item than by other approaches such as optical scanning.

Tracking tagged items with RFID is valuable to retailers because it reduces manual receiving and inventory management procedures. Products can be tracked automatically from distribution centers to storerooms and from storerooms to the store's retail area. Interrogators in the retail area can provide real time indication of low stock or misplaced items and speed customer checkout. For example, the store clerk can accelerate the checkout process as they are not required to individually process each of the items a customer brings to the checkout counter. Simply placing the items in the vicinity of the interrogator is all that is typically needed to interrogate the RFID tags and checkout items.

This can become problematic when an interrogator interrogates a specific RF Tag in the presence of a multitude of other tags (associated with a multitude of other inventory items). The interrogator can receive the data from the RFID tag, but will not know the location of the tag.

Typically an RFID system includes one or more interrogators and an RFID tag for each item to be tracked. The interrogator includes a radio transmitter to send the signal to the RFID tag and a radio receiver to receive signals sent back from the RFID tag. The interrogator can also typically be connected to a computer network so that the information from the various RFID tags can be centrally gathered and processed.

The RFID tag typically includes an antenna and an integrated circuit chip. The integrated circuit chip can include the radio transmitter and receiver functions along with data storage. The data stored on the chip can range from a simple product identifying number to extra identifying data to further identify the object itself. It is also possible for data to be written into the chip from various interrogators. For example, the location history of a product can be written into an RFID tag as the tagged product is moved from the storeroom to the sales area and perhaps to other associated retail outlets.

RFID tags are typically classified as either active or passive. Passive tags derive their energy from the interrogating radio signal and are generally limited in application to product checkout where the tagged item can be placed in proximity to the interrogator's antenna. Active tags contain a battery as an energy source and can broadcast a radio signal over a greater range.

The significant difference between active and passive tags is that passive tags (including the battery assisted passive tags) use the continuous wave (CW) from the interrogator to modulate the response back to the interrogator, also called a backscatter response.

Over the last several years the read range of passive tags have increased and, with the ascent of battery assisted passive tags, have reached read ranges of about 150 feet. While this is an advance, longer ranges would be more advantageous.

In inventory management, it is not only important to know the number of specific items. It is also desirable to know the precise location of a tagged object. Range to a tagged object can be estimated by measuring the propagation time of a radio signal sent to and from a tag.

Passive RFID tags are useful in not requiring an on-board battery while still retaining the capability to be interrogated. However, there are currently no systems on the market that allow for ranging to a passive RFID tags.

There is therefore a need for systems and methods that allow for not just the interrogation of passive RFID tags but also for their location.

There is also a need for passive RFID tags which can be interrogated from longer distances than currently available.

### SUMMARY OF INVENTION

The present invention provides systems and methods for use in reading and locating passive RFID tags. A reader/locator system sends out a signal with varying frequency. A tag reflects the signal back and the receiver portion of the reader/locator system receives the signal after a certain propagation delay. Since during this propagation delay the transmit frequency has changed, the received signal frequency differs from the one is currently transmitted. The received signal gets mixed with the currently transmitted signal and the resulting beat frequency depends on the frequency variation pattern (which is known) and the signal propagation delay. This beat frequency is directly proportional to the distance between the reader/locator and the RFID tag. The beat frequency can therefore be used to estimate this distance between the reader/locator and the RFID tag. Also provided are methods for determining if an incoming signal is data bearing and a method to obtain a cleaner incoming signal by storing a “carbon footprint” or background clutter and subtracting the carbon footprint from the incoming signal. A novel type of passive RFID tag is also disclosed.

In a first aspect, the present invention provides a reader/locator system for reading and locating RFID (radio frequency identification) tags, the system comprising:
a transmitter circuit for transmitting a signal;
a receiver circuit for receiving a received signal;
a frequency changing circuit for providing a frequency changing signal with a frequency change over time for the purpose of ranging to said transmitter circuit for transmission to said tags, said frequency changing signal having a frequency which is swept across a specific frequency band;
a calculation circuit for determining a beat frequency derived from a modulated version of said frequency changing signal received from a specific tags and said frequency changing signal;
   wherein
said system is for use with passive RFID tags;
said beat frequency is used to calculate a distance between said system and a specific tag;
said beat frequency is a difference in frequency between said modulated version of said frequency changing signal received by said system and said frequency changing signal transmitted from said system.

In a second aspect, the present invention provides a method for estimating a distance between a reader/locator system and a passive RFID (radio frequency identification) tag, the method comprising:

a) transmitting a frequency changing signal from said system to said tag

b) receiving at said system a modulated version of said frequency changing signal from said tag

c) mixing said modulated version of said frequency changing signal with an original frequency changing signal

d) determining a frequency of a result of step c), said frequency of said result being a beat frequency,

e) estimating said distance based on said beat frequency.

In a third aspect, the present invention provides a long range battery assisted passive RFID tag comprising:
an on-board battery;
a receive amplifier for receiving a received signal and for amplifying said received signal;
a signal control block for receiving an amplified received signal from said receive amplifier and for producing a modulated version of said received signal, said modulated version of said received signal being for transmission to an RFID reader/locator;
a transmit amplifier for amplifying said modulated version of said received signal;
a coupler coupled to at least one antenna and to said receive amplifier and to said transmit amplifier, said coupler coupling said receive amplifier and said transmit amplifier to said at least one antenna
   wherein
said signal control block modulates said received signal based on data to be transmitted to said RFID reader/locator.

### BRIEF DESCRIPTION OF THE DRAWINGS

The invention will be described with reference to the accompanying drawings, wherein

FIG. 1 is a block diagram of an overview of the operation of passive RFID tags in conjunction with one aspect of the invention;

FIG. 2 is a block diagram of a system according to one aspect of the invention;

FIG. 3 is an illustration of a linear chirp waveform used with one aspect of the invention;

FIG. 4 is an illustration of a step-wise chirp waveform used with another aspect of the invention;

FIG. 5A is an illustration of a resulting waveform after non-rearranged received signals have been mixed with transmitted signals;

FIG. 5B is an illustration of the waveform of FIG. 5A after the various samples have been rearranged according to another aspect of the invention;

FIG. 6 is an illustration of a waveform showing a mixing of an incoming signal and a received signal;

FIG. 7A is a waveform of an incoming signal having data encoded therein;

FIG. 7B is a waveform of an incoming signal devoid of data;

FIG. 8 is a block diagram of two paths used in a method used to determine if an incoming signal has data encoded therein;

FIG. 9 is a flowchart detailing the various steps in a method according to one aspect of the invention;

FIG. 10 illustrates the different components of known passive, semi-passive, and active RFID tags;

FIG. 11 is a block diagram of a long range battery assisted passive RFID tag according to another aspect of the invention; and

FIG. 12 illustrates the components in a novel long-range battery assisted passive RFID tag according to one aspect of the invention.

FIG. 13 shows one of the implementations of a TX LNA.

### DETAILED DESCRIPTION OF THE INVENTION

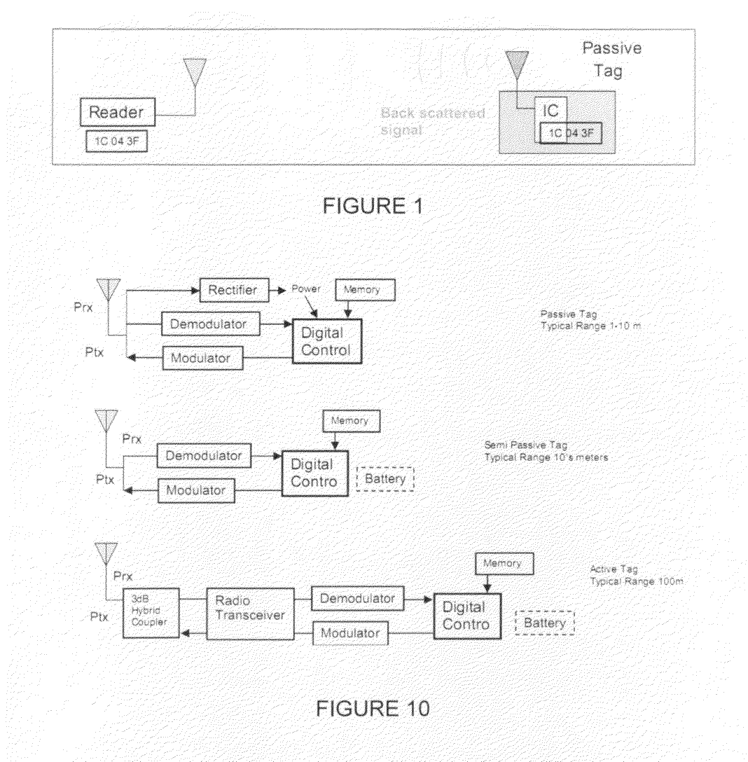

To clarify the function of the invention, an overview of passive RFID operations is provided in FIG. 1. The reader/locator communicates with a passive RFID by means of a ASK (amplitude shift keying) modulated RF signal with changing carrier frequency. The RFID tag receives power from the RF signal of the reader/locator and reads a command from the reader/locator.

The reader/locator then continues to radiate an unmodulated changing frequency signal to energize the tag. After receiving a command from the reader/locator the tag starts to modulate its antenna impedance with a certain delay. The RF power transmitted by the reader/locator is back scattered by the tag antenna, thereby creating an RF signal at the receiver antenna of the reader/locator modulated with the information stored in the tag.

The reader/locator then receives the modulated frequency changing signal from the RFID tag. The modulation of the received frequency changing signal contains the data being transmitted from the RFID tag to the reader/locator. The modulated frequency changing signal is also used as a way to determine the range between the reader/locator and the RFID tag. Data contained in the modulated frequency changing signal may then be extracted from the signal by the reader/locator.

To assist in the extraction of the data within the modulated frequency changing signal, the reader/locator can extract the background clutter from the received signal. This is done by first receiving reflected signals from the surrounding environment when there are no RFID tags transmitting. The summation of these reflected signals (also called a “carbon footprint” or background signal clutter) is then stored by the reader/locator. When a data signal is received from an RFID tag, the stored carbon footprint is subtracted from the received signal. This produces a cleaner version of the signal and a clearer version of the data from the tag.

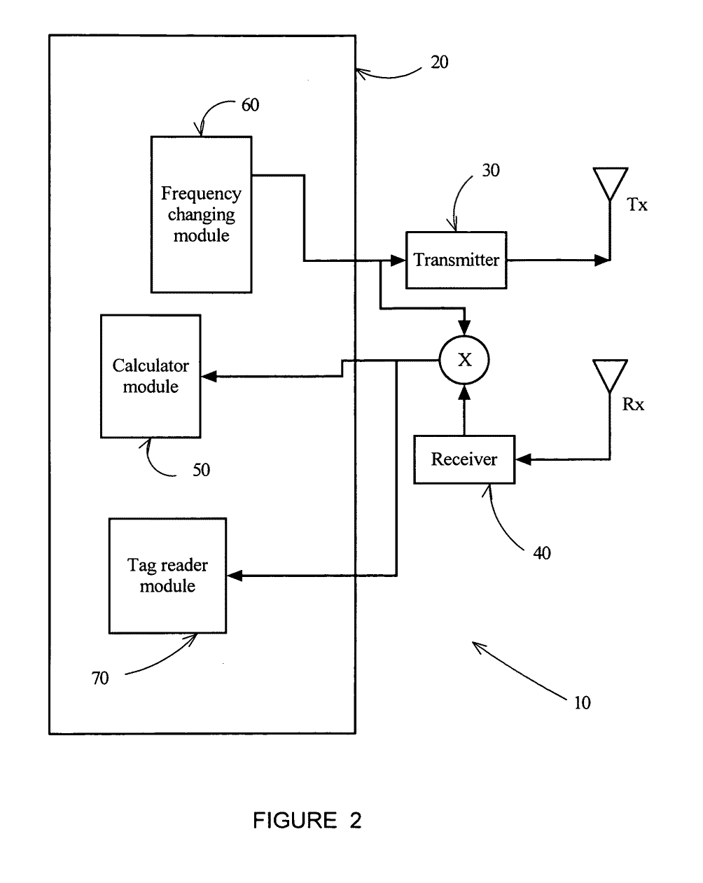

Referring to FIG. 2, a block diagram of an RFID tag read/locator 10 according to the invention is illustrated. It should be noted that this reader/locator is preferably configured to communicate with and locate passive RFID tags.

Referring to FIG. 2, the system 10 has a signal processing block 20 that communicates with a signal transmit module 30 and a signal receive module 40. The signal transmit module 30 contains a transmitter circuit for transmitting a signal while the signal receive module 40 contains a receiver circuit for receiving a signal. The signal processing block 20 contains a calculation circuit module 50. A frequency changing circuit 60 is also located within the signal processing block 20. A tag reader module 70 is also present in the signal processing block 20.

The signal processing block 20 receives received signals from the signal receive module 40 and sends signals to be transmitted to the signal transmit module 30. The signal processing block 20 extracts data encoded in the received signal. The signal processing block 20 also stores the carbon footprint and, where necessary, subtracts it from the received signal. The calculation circuit module 50 handles the actual subtraction of the carbon footprint as well as the range estimation and any other mathematical operations required.

The tag reader module 70 retrieves the data from the received signal. This module also processes the data from the RFID tag according to well-established and well-known protocols.

The range estimation or ranging function of the reader/locator is based on the idea that the time between a signal's original transmission and its reception after being reflected from an RFID tag is proportional to double the distance between the original transmitter and the RFID tag. By determining the difference in frequency between the originally transmitted signal and the received signal (a δf), this range or distance can be accurately estimated. This difference in frequency (also known as the beat frequency) is the sequence of phases which vary depending on the dwell frequency.

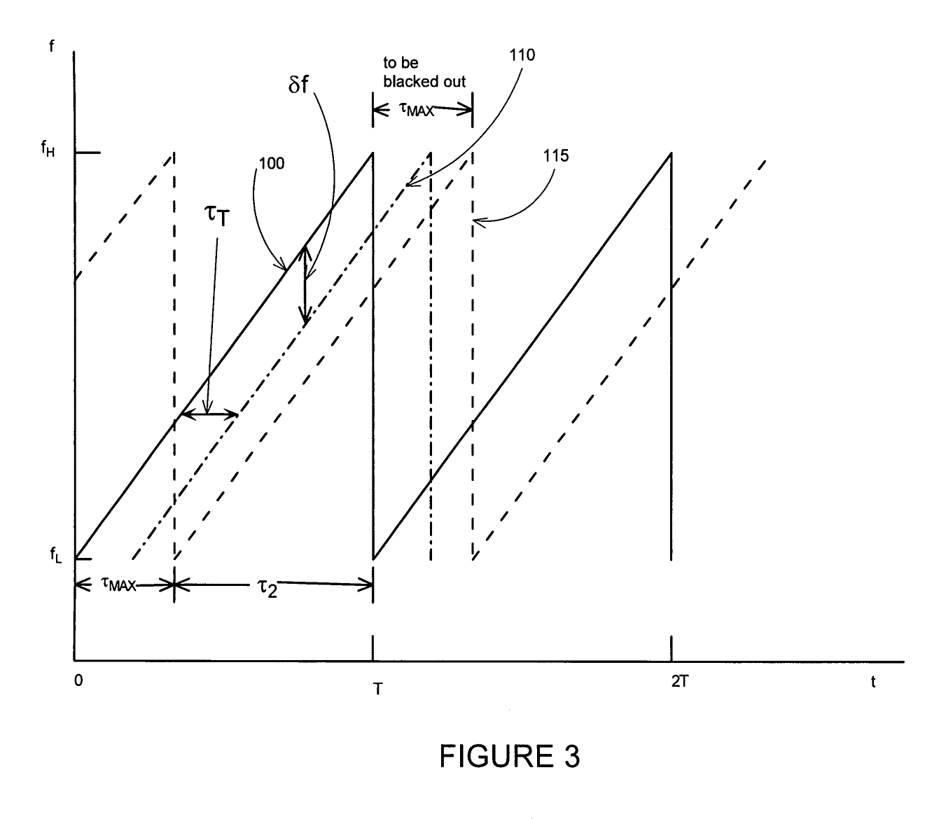

Referring to FIG. 3, a linear chirp (or a linear change in the frequency of the signal) is illustrated as being used in accordance with one embodiment of the invention. As can be seen, the signal being transmitted has a frequency that is linearly increased from f_{L} to f_{H} and that, for the initial instance of the signal, the signal is transmitted from time 0 to time T. At time T, the cycle is repeated as the signal frequency drops from f_{H} to f_{L} and is then linearly increased again to f_{H}. The cycle then repeats. Waveform 100 represents the original signal being transmitted to the tag while waveform 110 (dashed line) represents the signal being received from the tag. The difference in frequency between these two waveforms (δf) is proportional to the distance or range between the reader/locator and the tag.

It should be noted that while this document mentions an increasing frequency for the frequency changing signal, for example, a decreasing frequency for the frequency changing signal may also be used.

It should also be noted that, to derive the difference in frequency (or the beat frequency) between the incoming and the outgoing signals, the reader/locator mixes the outgoing (being transmitted) signal with the incoming (being received) signal. As the incoming waveform is merely a time delayed version of the outgoing waveform, the result of this mixing will have a frequency that is equal to the difference in frequency between the two waveforms or the beat frequency.

In a linear chirp, the instantaneous frequency f(t) varies linearly with time as shown in FIG. 3:

f(t)=f_{L}+k*t

where f_{L} is the starting frequency (at time t=0) or the lowest frequency in the used band, and k is the rate of frequency increase or chirp rate equal to k=(f_{H}−f_{L})/T, where T is the chirp period. The corresponding time-domain function for a linear chirp is:

$$x ( t ) = sin ( 2 π ( {f}_{L} + \frac{k}{2} t ) t )$$

The reflected signal from the object of interest arrives to the antenna with a delay τ_{T} which is determined by the distance to the object. For the time delay τ_{T} the transmit frequency changes by the value of Δf_{τ}=k*τ_{T}. Knowing this frequency change the distance can be calculated by the formula:

$$D = \frac{c {τ}_{T}}{2} = \frac{c \cdot Δ {f}_{τ}}{2 k}$$

where c is the speed of light.

Referring to FIG. 3, the maximum amount of time for the reflected signal to return to the reader/locator is represented by τ_{MAX} in the figure. (In FIG. 3, waveform 115 is represented as coming from the tag that is furthest from the reader/locator.) As can be seen, the sampling of the incoming signal should begin after an amount of time τ_{MAX} from the time the original signal is transmitted to avoid the ambiguity of mixing frequencies from adjacent chirp periods. Thus, for an interval lasting τ_{MAX} after the beginning of every cycle that the frequency changing signal is being transmitted, the incoming signal is not being sampled. (This can be seen in FIG. 3 where a time interval τ_{MAX} is shown as being a non-sampling interval or an interval to be blacked out.) The value for τ_{MAX} is, of course, dependent on the implementation details of the invention. An implementation designed to transmit to RFID tags that are at a maximum distance of 150 feet from the reader/locator would have a different τ_{MAX} value than and implementation designed to transmit to RFID tags that are, at a maximum, 50 feet away from the reader/locator.

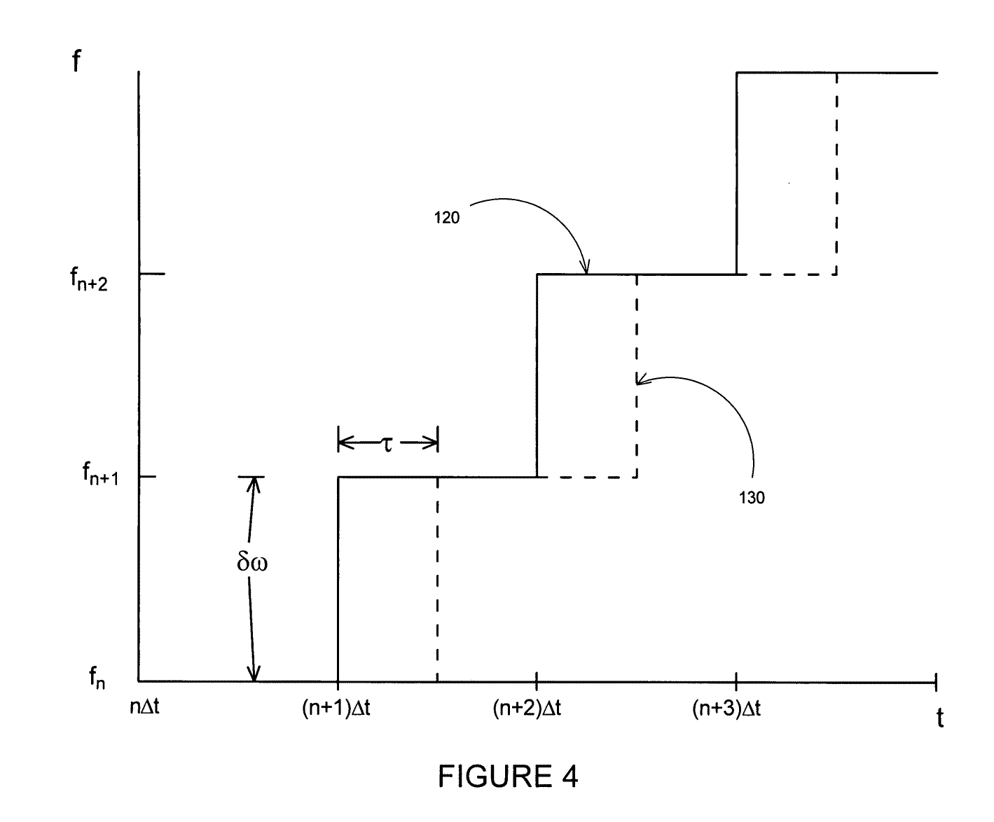

One possible issue with the above described method is that, depending on local regulations, a linear chirp signal may not be allowed to radiate maximum power. This limitation will, therefore, affect read ranges for the reader/locator. To address this issue, instead of a linear chirp, the chirp or increase in frequency may be done in a step wise manner (see FIG. 4). In FIG. 4, the transmitted waveform 120 lagged by the received waveform 130. As can be seen, instead of a linearly increasing frequency, the frequency of the signal being transmitted is increased by specific, predetermined and discrete amounts and at discrete, predetermined time intervals. Thus, f₀ is a known starting point, f₁ is f₀+δω, f₂ is f₀+(δω×2), f₃ is f₀+(δω×3) and so on. In terms of time intervals, the first increase in frequency is at (n+1)Δt, the second increase in frequency is at (n+2)Δt, and so on. Clearly, the values of δω and Δt are known and predetermined per reader/locator design parameters.

The resulting waveform is therefore that of a step ladder configuration. However, as with the linear chirp case, the sampling of the incoming signal must wait until the return signal from the farthest RFID tag has had enough time to return to the reader/locator. Again, the time interval τ_{MAX} (shown in FIG. 4) denotes the time when the incoming signal must not be sampled as doing so may result in erroneous range estimates. Only during the interval τ₂ (beginning at the end of τ_{MAX} in FIG. 4 and ending as the next step cycle begins) should the incoming signal be sampled. The first instance of this interval τ₂ is from the end of τ_{MAX} to (n+2)Δt. This sampling interval is the ideal sampling block and repeats at every cycle.

It should be noted that the stepwise manner in which the frequency is increased does not change the processing of the incoming signal. As with the linear chirp case, the incoming signal is mixed with the signal being transmitted and the frequency of the resulting signal is the beat frequency.

Again referring to FIG. 4, let us start our consideration for the time slot n at the moment of nΔt+τ_{MAX}, when the transmit signal has been on at frequency fₙ=f₀+nδω for the time period of τ_{MAX}. At this time the returning signal that has been transmitted at the moment of nΔt starts to arrive. In the time interval of [nΔt+τ_{MAX}, (n+1)Δt] both the transmitted and received signals have the same frequency of fₙ and can be expressed as:

S′_{TX}(n)=A·Cos [(ω₀+n·δω)t]

S′_{RX}(n)=a·Cos [(ω₀+n·δω)(t−τ)]

After mixing these two signals together the product will contain terms with the sum and the difference frequencies. The sum frequency is a double of (ω₀+n·δω), which is filtered out by a low pass filter and the difference frequency is zero, which means that the product contains a DC component equals to:

S′_{MIX}(n)=α·Cos [(ω₀+n·δω)τ]

In the time slot (n+1) in the time interval of [(n+1)Δt, (n+1)Δt+τ_{MAX}] the transmitted signal frequency increased by δω, but the received signal still stays the same as in the previous time slot and these signals can be expressed as:

S_{TX}(n+1)=A·Cos [(ω₀+(n+1) δω)t]

S_{RX}(n+1)=a·Cos [(ω₀+n·δω)(t−τ)]

Now the mixer product (again excluding high sum frequency) equals to:

S′_{MIX}(n)=α·Cos [(ω₀+n·δω)τ]

This is not a DC but a portion of a sinusoid started at the same level as the DC in the previous time slot.

In the time interval [(n+1)Δt+τ_{MAX} . . . n+2)Δt,] the transmitted and received signals again have the same frequency of (ω₀+(n+1)·δω) and the product is a DC component equals to:

S′_{MIX}(n+1)=α·Cos [(ω₀+(n+1)·δω)τ]

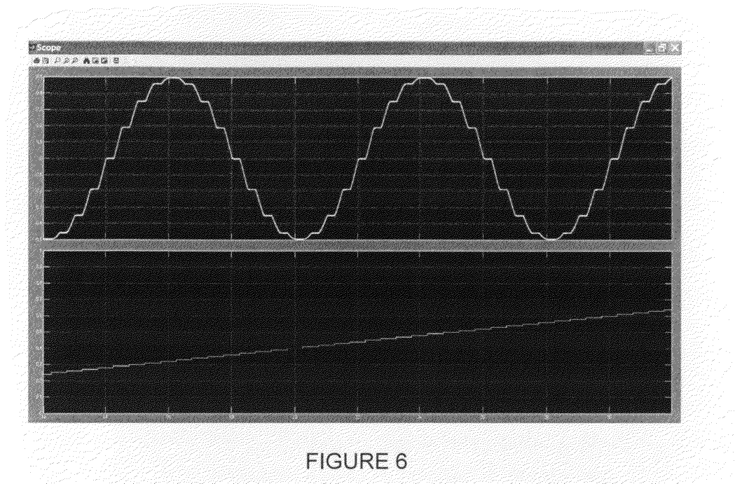

which equals to the mix product in the end of the previous interval at the time (n+1)Δt. Continuing on, it can be seen that the result of the mixer output is a sinusoid with DC inclusions as it is shown in the FIG. 6. The portions of the sinusoid and the DC inclusions are clearly seen. The sequence of the DC offsets is a sinusoidal wave. Its frequency is the same as the linear chirp case, i.e. the beat frequency.

To be able to use more power while conforming to local regulations, a frequency hopping method may be used. This may be done by simply predetermining the frequencies which will be transmitted using the ladder waveform shown in FIG. 4 and using these frequencies in a random (or pseudo-random) manner. The received signals, which will be at frequencies analogous to the transmitted frequencies, can then be rearranged to arrive at the step ladder waveform in FIG. 4. To better explain the above, assuming θ as a starting frequency, a progressive increase in frequency for the transmitted signal would result in a following sequence of frequencies being used (assuming 5 channels): θ+A₁, θ+A₂, θ+A₃, θ+A₄, θ+A₅. A pseudo-randomizing of this may give the following sequence of frequencies used: θ+A₅, θ+A_{I}, θ+A₃, θ+A₉, θ+A₂. As should be clear from the example given above, Aₙ would be a multiple of A₁, n>1.

The basis for the rearranging of the samples of the received signal is the prior knowledge of the sequence of frequencies being used. From the example given above, it should be clear that since the sequence of frequencies being used is that of: θ+A₅, θ+A₁, θ+A₃, θ+A₄, θ+A₂, then the sequence of frequencies for the incoming signal should be the same. Thus, the samples from the second sampling interval of the incoming signal (corresponding to frequency θ+A₅) should be placed at the beginning of the rearranged sequence while the samples from the first sampling interval (corresponding to frequency θ+A₅) should be placed fifth in the rearranged sequence, and so on.

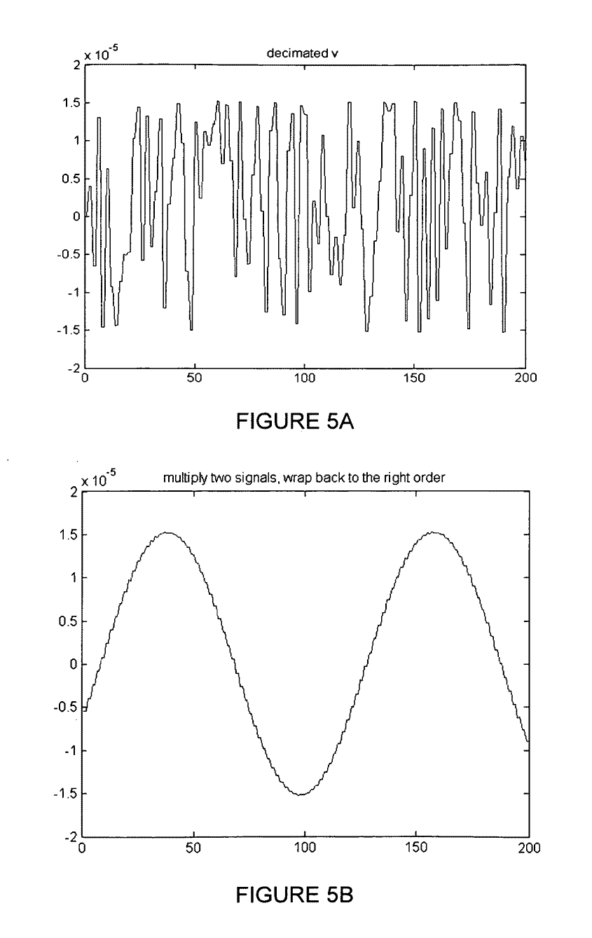

To illustrate the above, FIG. 5A illustrates the resulting waveform after the non-rearranged received signal has been mixed with the transmitted signal. After rearranging the various samples as noted above, the resulting waveform is that illustrated in FIG. 5B. As can be seen, the step-ladder sinusoidal waveform has been recovered.

Once the received signals have been received, they are then mixed with the signal being transmitted. After the mixing, the carbon footprint data is then subtracted from the resulting mixed signals. The result after subtracting the carbon footprint data is then processed to find the beat frequency. To extract this beat frequency, a double derivative of the mixed signal from the transmitted signal and the received signal is used. Since the resulting mixed signal is a sinusoid with frequency ω (i.e. y(t)=sin ωt), then taking the double derivative of the resulting mixed signal results in

d²y/dt²=−ω² sin ωt

Since we are interested in w, then the above equation results in:

$$\frac{\frac{{d}^{2} y}{d {t}^{2}}}{y ( t )} = \frac{\frac{{d}^{2} y}{d {t}^{2}}}{sin ω t} = - {ω}^{2}$$

Thus, taking the second derivative of the resulting mixed signal and then dividing that by the same resulting mixed signal gives us the minus of the square of the beat frequency. By converting the angular frequency from radians to Hz, we can derive the estimated range between the reader/locator and the tag.

To perform the above mathematical manipulation using the different channels with the different frequencies, we begin by calculating N*y(n) by averaging the values for each of the frequency hopping channels (N being the number of channels). Then, we calculate the N−2 point z(n), the second order derivative of y(n) divided by y(n) according to the following equation:

$$z ( n ) = \frac{{y}_{n + 1} + {y}_{n - 1} - 2 * {y}_{n}}{Δ {t}^{2} * {y}_{n}}$$

The median of z(n) is then calculated and, from this, the estimated frequency ω is found in radians: ω={square root over (−median(z(n)))}. The estimated frequency is then converted into Hz and the resulting beat frequency can then be used to directly estimate the range.

It should be noted that, to estimate the beat frequency, other classical techniques may be used (for example Fast Fourier Transform (FFT)) when having a wider bandwidth.

To determine if an incoming signal has data from an RFID tag, the presence or absence of high frequency components can be taken advantage of. Since the RFID tag encodes data to be transmitted to the reader/locator by switching its reflection coefficient at a known data rate (representing the data being encoded), the received signal with data encoded within it should have high frequency data encoded within. Distinguishing between signals with and without high frequency data encoded can be done in two ways.

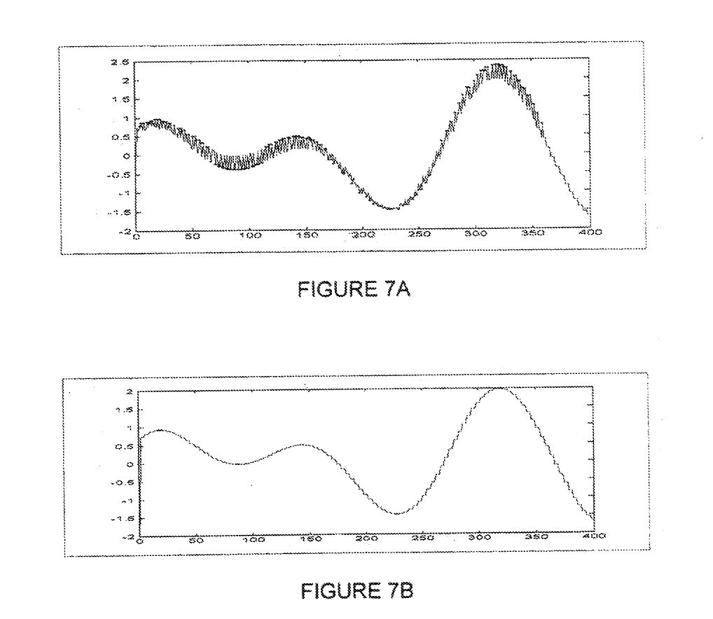

The first method for determining if data is present merely involves counting a number of peaks in the signal. Referring to FIG. 7A and FIG. 7B, FIG. 7A is a time domain waveform with high frequency data encoded within it while FIG. 7B is the same time domain waveform without data encoded. As can be seen, the waveform in FIG. 7A has a higher number of local peaks in the waveform while the waveform in FIG. 7B is relatively smooth. Since the incoming signal is sampled at specific instances in time for predetermined lengths of time (referred to as blocks) the number of peaks encountered during each block can be used to determine if that block contains encoded data. FIGS. 7A and 7B show the waveform for one sampling block.

It should be noted that the number of peaks required to be able to classify an incoming block as being data bearing or not is application or implementation specific and may be determined experimentally. As an example, one implementation may show that approximately x or more peaks per sampling block is the threshold for determining that a block contains encoded data while approximately y or less peaks per block indicates an absence of encoded data. Thus, for each sampling block of the incoming signal, if the number of peaks is x or higher, then that sampling block contains encoded data and must be processed further. If there are y or less peaks in a sampling block of the incoming signal, then that sampling block does not contain encoded data and the sampled data can be used as part of the carbon footprint as will be discussed below. If the number of peaks in a sampling block is between x and y, then the result is indeterminate. The sampling block is thus not usable and can be discarded.

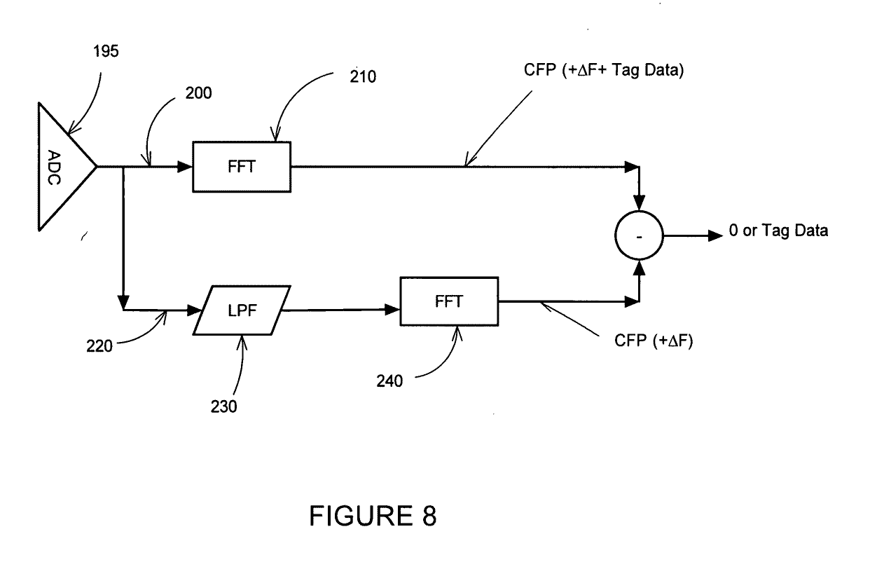

Another method which may be used to determine if an incoming signal has data is also based on the detection of high frequency components. Referring to FIG. 8, the incoming signal is first converted from analog to digital using an ADC (analog-to-digital converter) 195 and the resulting digitized signal is sent to two parallel paths. On the first path 200, the signal passes through a Fast Fourier Transform (FFT) 210. The signal is therefore just the carbon footprint along with whatever data may be encoded in the signal. On the second path 220, the signal passes through a low pass filter (LPF) 230 and then through another Fast Fourier Transform (FFT) 240. The resulting signals from the two paths are then subtracted from one another. If the signal contained data, then the data is extracted by the subtraction process. However, if the signal did not contain data, then a zero signal results.

If an incoming signal does not contain data from an RFID tag, that signal need not be useless. As explained above, a carbon footprint or a summation of what might be termed as “background radio signal reflection noise” is saved by the system. This carbon footprint can thus be subtracted from all incoming data bearing signals to provide a cleaner signal from which the data can be extracted. The carbon footprint signal is the result of transmitted radio signals reflected from the surrounding area of the reader/locator. Any incoming signal which is not data bearing from the RFID tag can be added to the stored carbon footprint data.

The memory used to store the carbon footprint may be located in any of the modules in the system 10. Mathematical functions required for the processing of both incoming and outgoing signals are performed by the calculation circuit module. The calculation circuit module may be implemented as a digital signal processor.

The reader/locator system may be implemented as an ASIC (application specific integrated circuit), FPGA (fixed pin grid array) or as any number of dedicated circuit boards integrated with a general purpose computer.

It should be noted that any useful data processing means may be used with the invention. As such, ASICs, general purpose CPUs, and other data processing devices may be used, either as dedicated processors for the calculations or as general purpose processors for a device incorporating aspects of the invention. The invention may be used to enhance currently existing RFID readers or other RFID centric devices or systems.

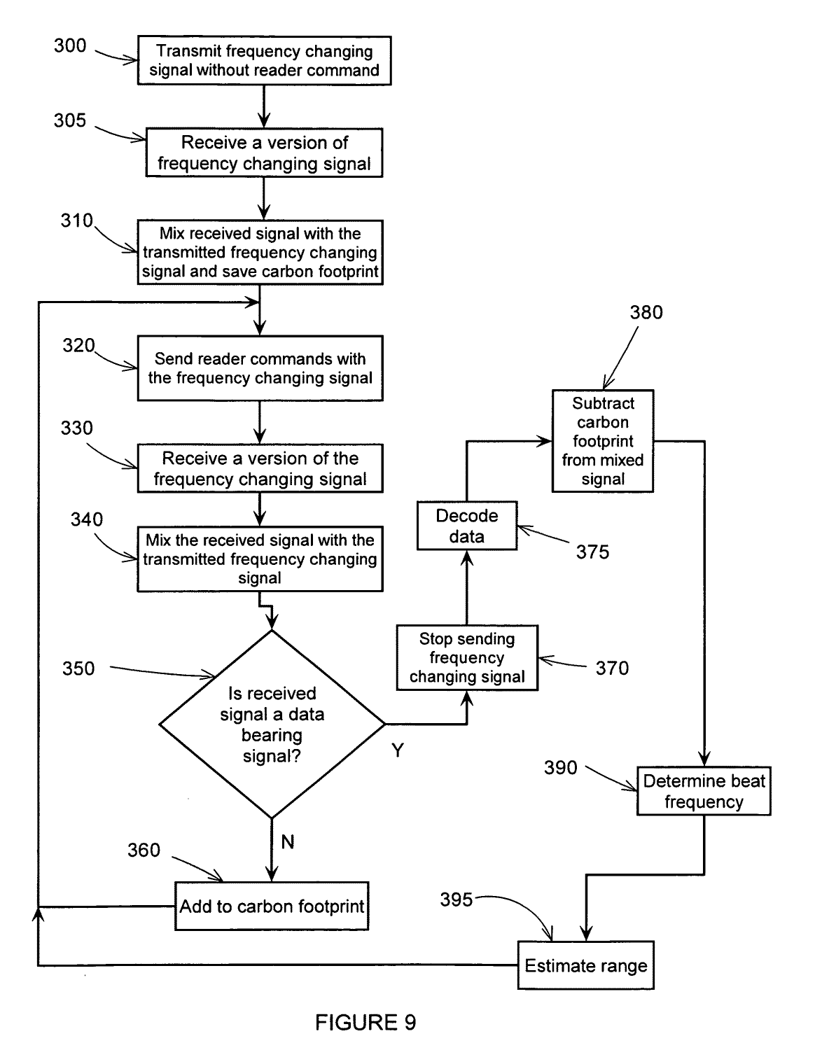

The range estimation method mentioned above may be summarized by the flowchart in FIG. 9. The process begins at step 300 with the reader/locator transmitting a frequency changing signal without the reader command. The reader/locator receives a frequency changing signal at step 305, the received signal is mixed with the transmitted signal and saved as the carbon footprint at step 310. Then at step 320 the reader/locator transmits a frequency changing signal with the reader command encoded in the signal to a specific RFID tag. At step 320, after sending the reader command with the frequency changing signal, the reader/locator continues to transmit the frequency changing signal while waiting for and receiving tag reply.

In step 330, the reader/locator receives a version of the frequency changing signal originally transmitted in step 320. At this point, it is unknown whether the received signal is reflected from the specific RFID tag or not. Step 340 then mixes the received signal with the signal transmitted in step 320. This is done primarily to be able to obtain the beat frequency between the received signal and the originally transmitted signal.

Decision 350 then determines if the received signal contains data (i.e. whether it is a data-bearing signal). As noted above, this may be accomplished using a number of techniques. If the received signal is not a data-bearing signal, then it may be used to update the carbon footprint (step 360).

On the other hand, if the received signal is a data-bearing signal, the reader/locator stops sending the frequency changing signal at step 370. Step 375 then decodes the data from the mixed signal. Step 380 subtracts the carbon footprint from the mixed signal resulting from step 340. Step 390 then extracts the beat frequency the mixed signal and step 395 estimates the range from the reader/locator to the tag. It should be noted that steps 375 and 380-395 may be executed in parallel or in any other sequence.

With the range found, the process restarts by looping to step 320 or the process stops based on the preprogrammed modes or external control signals.

To address the limited range of some passive RFID tags, the reader/locator system may be used with a long range battery-assisted passive RFID tag.

Regular passive, semi-passive, and active tags have internal components as shown in FIG. 10. However, none of these tags have the cost advantages of the passive tags over active tags while also having the range advantages of the active tags over the passive tags. A novel long range battery assisted passive (LR-BAP) tag improves the read distance by improving the read sensitivity of the tag and also improves the signal to noise ratio of the backscattered signal.

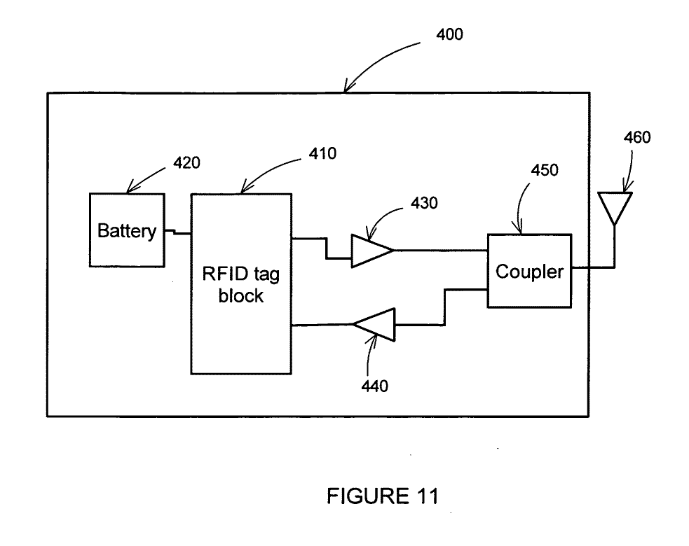

Referring to FIG. 11, the long range BAP 400 has an RFID tag block 410, a battery 420, a transmit amplifier 430, a receive amplifier 440, and a coupler 450. The antenna 460 is coupled to the coupler 450. The coupler 450 receives an amplified signal from transmit amplifier 430. A received signal is sent from the coupler 450 to the receive amplifier 440. The RFID tag block 410 sends a signal to be amplified and transmitted to the transmit amplifier 430 and receives an amplified received signal from receive amplifier 440. The receive amplifier and transmit amplifier may be low-noise amplifiers (LNA) for best results.

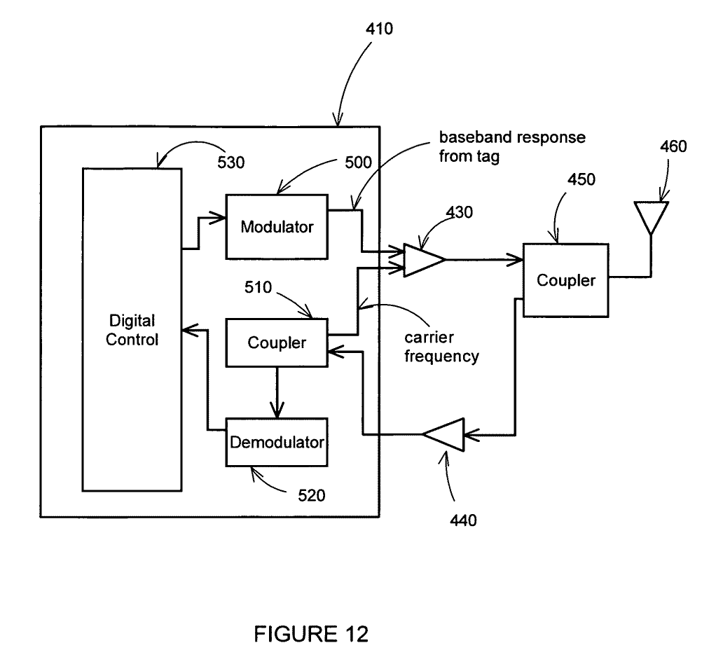

Referring to FIG. 12, it can be seen that the RFID tag block 410 contains a modulator 500, a coupler 510, a demodulator 520, and a digital control block 530. The modulator 500 receives an output of the digital control block 530 and modulates the output based on data to be transmitted to the reader/locator. The output of the modulator 500 is then amplified by the transmit amplifier 430.

Again referring to FIG. 12, the coupler 510 receives an output of the receive amplifier 440 and couples this to the demodulator 520. The demodulator 520 then sends its output to the digital control block 530.

In one implementation, the coupler 450 is a 3 dB hybrid coupler while the coupler 510 is a −10 dB coupler. Based on this implementation, on the receive path, the received signal will be amplified by 5.5 dB compared to passive and semi-passive tags as follows:

Received Power into demodulator (BAP)=Prx−Loss

Received Power into demodulator (Long Range-BAP)=Prx−Loss−(Hybrid Coupler gain)+(Gain Rx LNA)−(Coupler)

As an example, if the parameters of the LR-BAP are as follows:
Hybrid loss is −4 dB
−10 dB Coupler Insertion Loss is −0.5 dB
LNA gain is 10 dB

Based on the above parameters, then the overall downlink gain improvement is +10-4.5=5.5 dB. The gain directly improves downlink maximum range.

The receive amplifier 440 is preferably turned ON on a small duty cycle to conserve power or will is always powered, in order to continuously monitor reader commands. In contrast, the transmit amplifier 430 is powered ON only when a tag is responding.

The uplink connection performance is also improved due to the presence of the transmit amplifier 430. A received signal is amplified by the receive amplifier 440, modulated by the modulator 500 and then further amplified by the transmit amplifier 430. The signal is then transmitted by way of the antenna 460.

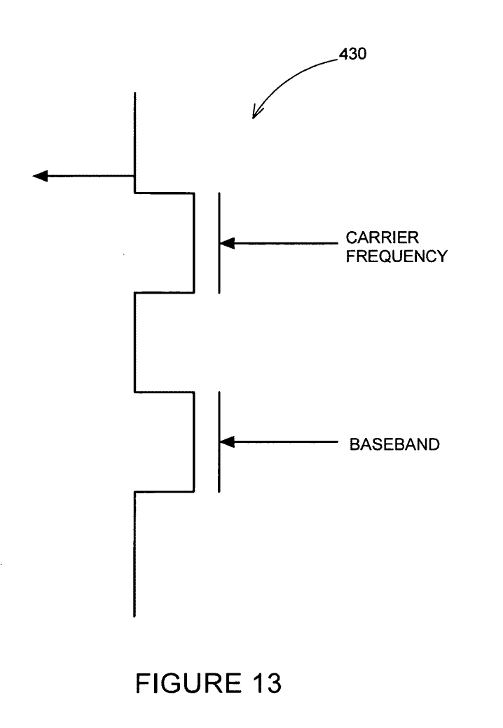

Referring to FIG. 13, one implementation of a transmit low noise amplifier (TX LNA) is illustrated.

It should be noted that while FIGS. 10 and 11 illustrate a single antenna 460, multiple antennas may be used depending on the implementation of the RFID tag.

The method steps of the invention may be embodied in sets of executable machine code stored in a variety of formats such as object code or source code. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A reader/locator system for reading and locating RFID (radio frequency identification) tags, the system comprising:
a transmitter circuit for transmitting a signal;
a receiver circuit for receiving a received signal;
a frequency changing circuit for providing a frequency changing signal to said transmitter circuit for transmission to said tags, said frequency changing signal having a frequency which changes over time for estimating a range between said system and an RFID tag, said frequency changing signal having a frequency which is swept across a specific frequency band;
a calculation circuit for determining a beat frequency derived from a modulated version of said frequency changing signal received from a specific tag and said frequency changing signal;
wherein
said system is for use with passive RFID tags;
said beat frequency is used to calculate a distance between said system and a specific tag;
said beat frequency is a difference in frequency between said modulated version of said frequency changing signal received by said system and said frequency changing signal transmitted from said system.

2. A system according to claim 1 wherein said frequency changing signal is swept across said frequency band in a step wise manner.

3. A system according to claim 2 wherein said frequency of said frequency changing signal is swept across said band in specific predetermined increments.

4. A system according to claim 1 wherein said modulated version of said frequency changing signal is sampled by said system to determine said beat frequency only after a predetermined time interval after a beginning of each sweep of said frequency of said frequency changing signal across said band.

5. A system according to claim 1 wherein said frequency changing signal being transmitted is frequency multiplied with said modulated version received from said tag to obtain said beat frequency.

6. A system according to claim 1 wherein said system further comprises memory means for storing a carbon footprint of an area surrounding said system, said carbon footprint being a summation of sinusoidal signals reflected by said area around said system.

7. A system according to claim 6 wherein said calculation circuit subtracts said carbon footprint from signals received from said specific tag.

8. A system according to claim 1 wherein said calculation circuit determines if an incoming signal is from said RFID tag based on a number of peaks present in said signal.

9. A system according to claim 1 wherein said system determines if an incoming signal is from an RFID tag by determining if said incoming signal contains data.

10. A system according to claim 9 wherein said system determines if an incoming signal contains data by determining if said incoming signal contains high frequencies components.

11. A system according to claim 5 wherein said beat frequency is derived from a result of said frequency multiplication between said frequency changing signal and said modulated version received from said tag, said beat frequency being obtained by using a double derivative of said result.

12. A method for estimating a distance between a reader/locator system and a passive RFID (radio frequency identification) tag, the method comprising:
a) transmitting a frequency changing signal from said system to said tag
b) receiving at said system a modulated version of said frequency changing signal from said tag
c) mixing said modulated version of said frequency changing signal with an original frequency changing signal
d) determining a frequency of a result of step c), said frequency of said result being a beat frequency,
e) estimating said distance based on said beat frequency.

13. A method according to claim 12 wherein step e) is accomplished by using a formula
$$D = \frac{c τ}{2} = \frac{c \cdot Δ {f}_{τ}}{2 k}$$
where c is a speed of light,
Δf_{τ} is said beat frequency, and
k is a chirp rate (k=(f_{H}−f_{L})/T where T is a chirp period and f_{H} and f_{L} are a maximum and a minimum frequencies in a frequency range of said frequency changing signal).

14. A method according to claim 12 further including the step of subtracting a carbon footprint from said modulated version of said frequency changing signal prior to step d), said carbon footprint being a summation of sinusoidal signals reflected by said area around said system

15. A method according to claim 12 further including the step of increasing a frequency of said frequency changing signal in a stepwise manner.

16. A method according to claim 12 wherein a frequency of said frequency changing signal is swept across a predetermined frequency band in specific predetermined increments.

17. A method according to claim 16 further including the steps of predetermining frequencies to be used by said frequency changing signal and randomizing an application of said frequencies to said frequency changing signal prior to step a).

18. A method according to claim 16 further including the step of sampling said modulated version of said frequency changing signal only after a predetermined time interval after a beginning of each sweep of said frequency of said frequency changing signal across said band.

19. A long range battery assisted passive RFID tag comprising:
an on-board battery;
a receive amplifier for receiving a received signal and for amplifying said received signal;
a signal control block for receiving an amplified received signal from said receive amplifier and for producing a modulated version of said received signal, said modulated version of said received signal being for transmission to an RFID reader/locator;
a transmit amplifier for amplifying said modulated version of said received signal;
a coupler coupled to at least one antenna and to said receive amplifier and to said transmit amplifier, said coupler coupling said receive amplifier and said transmit amplifier to said at least one antenna
wherein
said signal control block modulates said received signal based on data to be transmitted to said RFID reader/locator.
